(19) United States
(12) Patent Application Publication
(10) Pub. No.: US 2013/0257916 A1
(43) Pub. Date: Oct. 3, 2013

(54) DISPLAY DEVICE AND DISPLAY METHOD AND ENCODING METHOD USING THE SAME

(71) Applicant: WISTRON CORP., New Taipei City (TW)

(72) Inventors: Meng-Chao Kao, New Taipei City (TW); Hui-Chen Lin, New Taipei City (TW); Szu-Fen Chen, New Taipei City (TW)

(73) Assignee: WISTRON CORP., New Taipei City (TW)

(21) Appl. No.: 13/658,708

(22) Filed: Oct. 23, 2012

(30) Foreign Application Priority Data
Apr. 2, 2012 (TW) 101111641

(51) Int. Cl. G09G 5/10

(52) U.S. Cl. 345/690

(57) ABSTRACT

The present disclosure discloses a display device including a display unit, a backlight module, a decoding device, and a backlight driver. The display unit includes a plurality of pixels, including a plurality of sub-pixels, arranged in a matrix. The decoding device decodes an encoded RGB data stream, and produces a dimming control signal, wherein the encoded RGB data stream is arranged to drive each of the sub-pixels to display a frame, the encoded RGB data stream includes a first set of the encoded RGB data stream corresponding to a row of pixels of the frame and having binary data corresponding to each of the light emitting elements, and the decoding device produces the dimming control signal according to the binary data. The backlight driver controls brightness of a plurality of light emitting elements of the backlight module according to the dimming control signal.

### CROSS REFERENCE TO RELATED APPLICATIONS

This application claims priority of Taiwan Patent Application No. 101111641, filed on Apr. 2, 2012, the entirety of which is incorporated by reference herein.

### BACKGROUND OF THE DISCLOSURE

1. Field of the Disclosure

The present disclosure relates to a display system, and in particular relates to a display system used for encoding dimming control data into an RGB data stream.

2. Description of the Related Art

Current electronic devices, such as mobile phones, digital cameras, digital recorders, personal digital assistants, or personal computers, are including more and more electronic modules (such as image modules, storage modules, and display modules, etc.) therein. Generally, the electronic devices have a backlight module and a matrix-type display used for displaying image.

Most conventional backlight modules are constantly illuminated. Therefore, a dimming method is required, both dynamically and regionally, for increased image contrast by adjusting the brightness according to the image data distribution and/or the surrounding light. For example, conventional backlight modules produce a high brightness output when the electronic device displays a bright image. On the other hand, conventional backlight modules produce a low brightness output to reduce light leakage when the electronic device displays a dark image. Therefore, a display with backlight control has higher dynamic contrast and lower power consumption. However, the display with backlight control requires a large number of circuits and operations to analyze images. In view of this, the purpose according to the present disclosure is to provide a display system with a coding method having a reduced number of circuits and operations to analyze images.

### BRIEF SUMMARY OF THE DISCLOSURE

A detailed description is given in the following embodiments with reference to the accompanying drawings.

The present disclosure discloses a display device including a display unit, a backlight module, a decoding device, and a backlight driver. The display unit includes a plurality of pixels arranged in a matrix, wherein each of the pixels includes a plurality of sub-pixels. The backlight module includes a plurality of light emitting elements. The decoding device is arranged to decode an encoded RGB data stream, and produce a dimming control signal, wherein the encoded RGB data stream is arranged to drive each of the sub-pixels of the display unit to display a frame. The encoded RGB data stream includes a first set of the encoded RGB data stream. The first set of the encoded RGB data stream corresponds to a row of pixels of the frame and has binary data corresponding to each of the light emitting elements respectively. The decoding device is arranged to produce the dimming control signal according to the binary data. The backlight driver is arranged to control brightness of each of the light emitting elements, respectively, according to the dimming control signal.

The present disclosure further discloses a display method, applied to a display device including a display unit, wherein the display unit includes a plurality of pixels arranged in a matrix and each of the pixels includes a plurality of sub-pixels. The display method includes: decoding a first set of the encoded RGB data stream of an encoded RGB data stream to produce a dimming control signal, wherein the encoded RGB data stream is provided to a display driver and used for driving the pixels of the display unit to display a frame, and the first set of the encoded RGB data stream corresponds to a row of pixels of the frame; transmitting the dimming control signal and the encoded RGB data stream to a backlight driver and the display driver; controlling brightness of a plurality of light emitting elements of a backlight module according to the dimming control signal; and driving the pixels of the display unit according to the encoded RGB data stream.

Additionally, the present disclosure further discloses an encoding method, applied to an encoding device. The method includes: producing a dimming control signal corresponding to an RGB data stream according to the RGB data stream, wherein the dimming control signal is provided to a backlight driver and used for controlling brightness of a plurality of light emitting elements of a backlight module, and the dimming control signal is binary data; resetting the least significant bit of each of a plurality of sub-pixel drive signals of a first set of the RGB data stream of the RGB data stream to zero, wherein the sub-pixel drive signals are binary data; and writing each of bits of the binary data of the dimming control signal into the least significant bit of each of the sub-pixel drive signals, respectively, to produce an encoded RGB data stream.

Furthermore, the present disclosure discloses a display method, wherein the method includes: producing a dimming control signal corresponding to an RGB data stream according to the RGB data stream, wherein the dimming control signal is binary data; resetting the least significant bit of each of a plurality of sub-pixel drive signals of a first set of the RGB data stream of the RGB data stream, wherein the sub-pixel drive signals are binary data; writing each of bits of the binary data of the dimming control signal into the least significant bit of each of the sub-pixel drive signals, respectively, to produce at least one encoded RGB data stream; decoding a first set of the encoded RGB data stream of the encoded RGB data stream to produce the dimming control signal, wherein the first set of the encoded RGB data stream corresponds to a row of pixels of a frame; transmitting the dimming control signal and the encoded RGB data stream to a backlight driver and a display driver; controlling brightness of a plurality of light emitting elements of a backlight module according to the dimming control signal; and driving a plurality of pixels of a display unit according to the encoded RGB data stream, wherein the pixels are arranged in a matrix.

### BRIEF DESCRIPTION OF THE DRAWINGS

The present disclosure can be more fully understood by reading the subsequent detailed description and examples with references made to the accompanying drawings, wherein:

FIG. 1 is a schematic diagram illustrating an embodiment of a playback system according to the present disclosure;

FIG. 2 is a schematic diagram illustrating an embodiment of a data stream according to the present disclosure;

FIG. 3 is a flowchart of an encoding method according to an embodiment according to the present disclosure;

FIG. 4 is a schematic diagram of the encoding method according to an embodiment according to the present disclosure;

FIG. 5 is a schematic diagram illustrating an embodiment of a data stream according to the present disclosure;

FIG. 6 is a flowchart of a displaying method according to an embodiment according to the present disclosure; and

FIG. 7 is a flowchart of another displaying method according to an embodiment according to the present disclosure.

### DESCRIPTION OF THE DISCLOSURE

The following description is of the best-contemplated mode of carrying out the disclosure. This description is made for the purpose of illustrating the general principles of the disclosure and should not be taken in a limiting sense. The scope of the disclosure is best determined by reference to the appended claims.

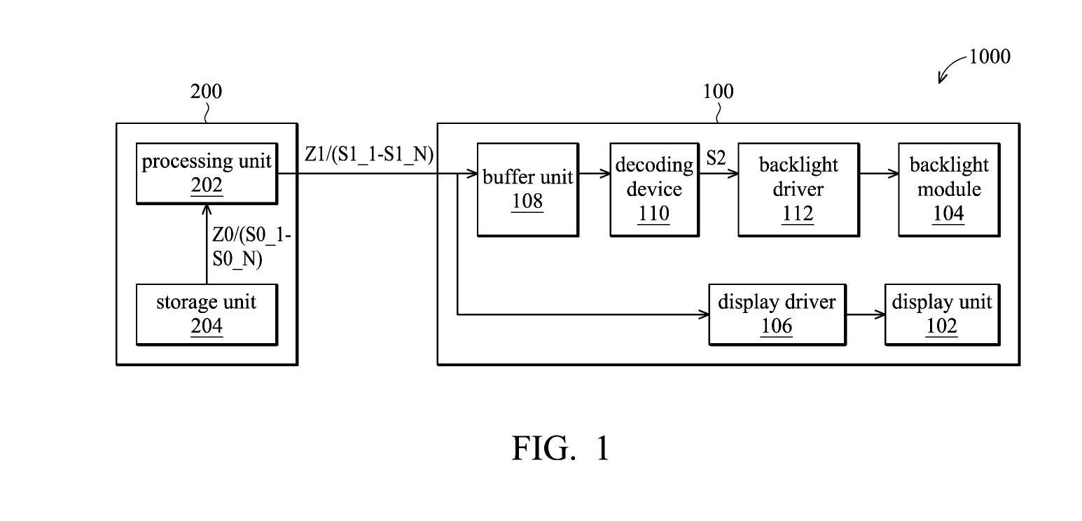

FIG. 1 is a schematic diagram illustrating an embodiment of a playback system according to the present disclosure. The playback system 1000 includes a display device 100 and an encoding device 200. The display device 100 is arranged to receive a data stream Z1, wherein the data stream Z1 includes at least one encoded RGB data stream S1_1-S1_N, and the display device 100 is arranged to display images according to the encoded RGB data streams S1_1-S1_N, wherein each of the encoded RGB data streams S1_1-S1_N is arranged to display a frame.

The display device 100 includes a display unit 102, a backlight module 104, a display driver 106, a buffer unit 108, a decoding device 110 and a backlight driver 112. In the exemplary embodiments, the display unit 102 can be a liquid crystal displayer, the display driver 106 can be a liquid crystal driver (LC Driver), the buffer unit 108 can be a line buffer, but all are not limited thereto.

The display unit 102 includes a plurality of pixels arranged in a matrix and used for displaying frames according to the data stream Z1, wherein each of the pixels of the display unit 102 includes a plurality of sub-pixels, and the data stream Z1 includes at least one encoded RGB data stream S1_1-S1_N. It should be noted that the following discussion is based on the encoded RGB data stream S1_1, but is not limited thereto. The encoded RGB data streams S1_2-S1_N can be referred to as the encoded RGB data stream S1_1. The encoded RGB data streams S1_1 is arranged to display a frame. For example, the display unit 102 includes 1080 rows of pixels when the display unit 102 has a resolution of (full high definition: FHD), wherein each of the rows includes 1920 pixels, and each of the pixels includes a sub-pixel used for emitting red light, a sub-pixel used for emitting green light, and a sub-pixel used for emitting blue light. The encoded RGB data stream S1_1 includes a plurality of sub-pixel drive signals corresponding to each of the sub-pixels, respectively. The encoded RGB data stream S1_1 includes a first set of the encoded RGB data stream, and the dimming control signal S2 is constituted by the least significant bit (LSB) of each of the sub-pixel drive signals of the first set of the encoded RGB data stream.

The backlight module 104 includes a plurality of light emitting elements. The light emitting elements are arranged to control the brightness of a plurality of backlight blocks by the local dimming technology, wherein each of the backlight blocks is constituted by at least one light emitting element. For example, the backlight module 104 can include 10-12 backlight blocks when the backlight module 104 is a cold cathode fluorescent lamp module (CCFL). The backlight module 104 can include hundreds of backlight blocks when the backlight module 104 is a light-emitting diode module (LED). The display driver 106 is arranged to drive each of the pixels of display unit 102 according to the encoded RGB data stream S1_1. Moreover, in another embodiment, the backlight driver 112 can be a cold cathode fluorescent lamp driver when the backlight module 104 is the cold cathode fluorescent lamp module.

The buffer unit 108 is arranged to retrieve the data from the encoded RGB data stream S1_1 in sequential order by rows. For example, the buffer unit 108 is arranged to sequentially retrieve the encoded RGB data stream S1_1 corresponding to the 1080 rows of pixels of a first frame, when the display unit 102 has a resolution of 1920×1080 (full high definition: FHD). Next, the buffer unit 108 continues to retrieve the encoded RGB data stream S1_2 corresponding to the 1080 rows of pixels of the next frame. In another the buffer unit 108 is arranged to retrieve the data of the first set of the encoded RGB data stream from the encoded RGB data stream S1_1 according to the horizontal sync signal or the vertical sync signal.

The decoding device 110 is arranged to decode the first set of the encoded RGB data stream of the encoded RGB data stream S1_1 in the buffer unit 108, and produce a dimming control signal S2, wherein the encoded RGB data stream S1_1 is arranged to drive the sub-pixels of the display unit 102. It should be noted that the encoded RGB data stream S1_1 includes the first set of the encoded RGB data stream, the first set of the encoded RGB data stream corresponds to a row of pixels of the display unit 102 (or a row of pixels of the frame) and includes binary data corresponding to the brightness of each of the light emitting elements, and the decoding device 110 produces the dimming control signal S2 according to the binary data of the first set of the encoded RGB data stream. It should be noted that, in one of the exemplary embodiments, the first set of the encoded RGB data stream is arranged to drive the first row of pixels of a frame. In another embodiment, the first set of the encoded RGB data stream is arranged to drive the last row of pixels of the frame, but is not limited thereto. Moreover, in another embodiment of the exemplary embodiments, the first set of the encoded RGB data stream is arranged to drive some of the pixels in one row, or the pixels in more than one row, but is not limited thereto.

In the present embodiment, the first set of the RGB data stream of the RGB data stream S0 is corresponding to the first row of pixels of the display unit 102 (or a row of pixels of the frame), and the decoding device 110 is arranged to decode the first set of the encoded RGB data stream in the buffer unit 108 to produce the dimming control signal S2 when the buffer unit 108 is retrieving the first set of the encoded RGB data stream which corresponds to the first row of pixels, wherein the first row is the uppermost row of a frame or the display unit 102.

In another embodiment, the first set of the RGB data stream is the data of the RGB data stream S0 corresponding to the last row of pixels of the display unit 102 (or the frame), and the decoding device 110 is arranged to decode the first set of the encoded RGB data stream in the buffer unit 108 to produce the dimming control signal S2 when the buffer unit 108 retrieves the first set of the encoded RGB data stream which corresponds to the last row of pixels.

The backlight driver 112 is arranged to control the brightness of each of the light emitting elements according to the dimming control signal S2, respectively. Therefore, the backlight driver 112 controls the brightness of a plurality of backlight blocks constituted by the light emitting elements, respectively.

The encoding device 200 includes a processing unit 202 and a storage unit 204 connected via a bus. In some of the exemplary embodiments, the encoding device 200 can include an identification device, a register, a storage unit, an application, and an operating system, etc. Moreover, those skilled in the art will understand that some embodiments of the encoding device 200 may be practiced with other computer system configurations, including handheld devices, portable devices, personal digital assistants (PDA), microprocessor-based or programmable consumer electronics, network PCs, minicomputers, mainframe computers, and the like.

The processing unit 202 may include a central-processing unit or a plurality of processing units, commonly referred to as a parallel processing environment. The processing unit 202 is arranged to implement the encoding method. The storage unit 204 may include a read only memory (ROM), a flash ROM, and/or a random access memory (RAM). In another embodiment, the storage unit 204 can be a hard disk drive, a floppy drive, a CD-ROM device or a flash device. The storage unit 204 is arranged to store the program modules used for executing by the processing unit 202 to perform message functions. Generally, the program modules include routines, programs, objects, components, scripts, Web pages, or others, that perform particular tasks or implement particular abstract data types.

In the present embodiment, the storage unit 204 is arranged to store the data stream Z0. The data stream Z0 is arranged to transmit the image data of the display unit, wherein the data stream Z0 includes at least one RGB data stream S0_1-S0_N, wherein each RGB data stream S0_1-S0_N is arranged to display a frame, respectively. It should be noted that the following discussion is based on the encoded RGB data stream S0_1, and the encoded RGB data streams S0_2-S0_N can be referred to as the encoded RGB data stream S0_1.

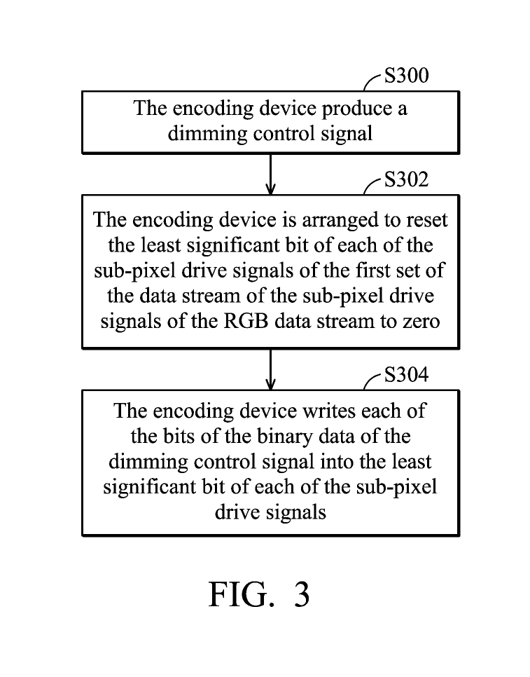

The processing unit 202 is arranged to produce a dimming control signal S2 according to the RGB data stream S0_1 of the storage unit 204. The processing unit 202 is further arranged to encode the dimming control signal S2 and the RGB data stream S0_1 to produce the encoded RGB data stream S1_1, and reference can be made to FIG. 3 for the detailed description of the encoding method.

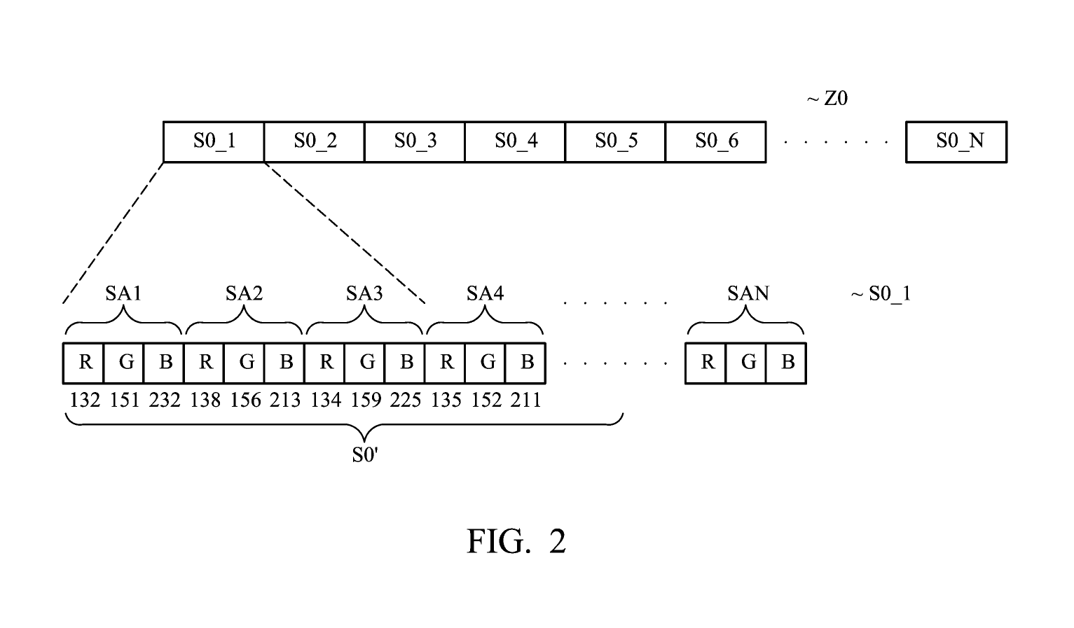

FIG. 2 is a schematic diagram illustrating an embodiment of a data stream according to the present disclosure. The data stream Z0 includes at least one RGB data stream S0_1-S0_N. It should be noted that the following discussion is based on the RGB data stream S0_1. The RGB data stream S0_1 is constituted by a plurality of pixel drive signals SA1-SAN corresponding to a plurality of pixels, respectively. Each of the pixel drive signals SA1-SAN includes three sub-pixel drive signals R, G, and B, which are used for controlling the brightness of the red sub-pixel, the green sub-pixel, and the blue sub-pixel of each of the pixels, respectively. The sub-pixel drive signals R, G, and B are binary data. For example, the sub-pixel drive signals R, G, and B of the pixel drive signal SA1 can indicate the grayscale values 132, 151, and 232 by using binary data, respectively. The sub-pixel drive signals R, G, and B of the pixel drive signal SA2 can indicate the grayscale values 138 156, and 213 by using binary data, respectively. The sub-pixel drive signals R, G, and B of the pixel drive signal SA3 can indicate the grayscale values 134, 159, and 225 by using binary data, respectively. Furthermore, the sub-pixel drive signals R, G, and B of the pixel drive signal SA4 can indicate the grayscale values 135, 152, and 211 by using binary data, respectively, wherein bigger sub-pixel drive signals indicate higher brightness of the corresponding sub-pixel. Moreover, the data stream Z1 can be divided into a plurality of the frame drive signals by frames (the RGB data streams S0_1-S0_N) according to the vertical synchronization signal, and each of the frame drive signals (the RGB data streams S0_1-S0_N) can be divided into a plurality of row drive signals by rows according to the horizontal synchronizing signal. In one of the exemplary embodiments, the processing unit 202 is arranged to select one of the row drive signals from each of the RGB data streams S0_1-S0_N to serve as the first set of the RGB data stream S0′ according to the horizontal synchronizing signal or the vertical synchronization signal. In one of the exemplary embodiments, the first set of the RGB data stream S0′ of the RGB data stream S0_1 is the data corresponding to the first row of pixels. Namely, the first set of the RGB data stream S0′ corresponds to the first row of pixels of the frame. In another embodiment, the first set of the RGB data stream S0′ of the RGB data stream S0_1 is the data corresponding to the last row of pixels. Namely, the first set of the RGB data stream S0′ corresponds to the last row of pixels of the frame.

FIG. 3 is a flowchart of an encoding method according to an embodiment of the present disclosure, wherein the encoding method is applied to the encoding device 200. The process starts at step S300. It should be noted that the following discussion is based on the RGB data stream S0_1, and the RGB data streams S0_2-S0_N can be referred to as the RGB data stream S0_1.

In the step S300, the encoding device 200 is arranged to produce a dimming control signal S2 which corresponds to the RGB data stream S0_1 according to the RGB data stream S0_1. The dimming control signal S2 is arranged to control the brightness of the light emitting elements, and the dimming control signal S2 is binary data. In one of the exemplary embodiments, the encoding device 200 is arranged to detect the maximum of each of the pixels of a backlight block in the RGB data stream S0_1, and produce the corresponding dimming control signal S2 by calculating the average of the maximums of the pixels of the backlight block in the RGB data stream S0_1, but is not limited thereto.

Next, in the step S302, the encoding device 200 is arranged to reset the least significant bit of each of the sub-pixel drive signals of the first set of the RGB data stream S0′ of the sub-pixel drive signals of the RGB data stream S0_1 to zero. The sub-pixel drive signals of the RGB data stream S0_1 are binary data provided to the display driver 106 for driving a plurality of sub-pixels of the pixels arranged in a matrix of the display unit 102. It should be noted that the processing unit 202 is arranged to select one of the row drive signals from the RGB data stream S0_1 to serve as the first set of the RGB data stream S0′ according to the horizontal synchronizing signal or the vertical synchronization signal. The first set of the RGB data stream S0′ is the data corresponding to the first row of pixels of a frame or the last row of pixels of the frame. In one of the exemplary embodiments, the processing unit 202 divides each of the sub-pixel drive signals of the first set of the RGB data stream S0′ by two to obtain a quotient and discards the remainder, and the multiplies the quotient by two, such that the least significant bit of the sub-pixel drive signals of the first set of the RGB data stream S0′ are reset to zero, but is not limited thereto. In another embodiment, the processing unit 202 is arranged to ignore the least significant bit of each of the sub-pixel drive signals of the first set of the RGB data stream S0′, and serve zero as the least significant bit of each of the sub-pixel drive signals of the first set of the RGB data S0′, such that the least significant bit of the sub-pixel drive signals of the first set of the RGB data stream S0′ are reset to zero, but is not limited thereto.

Next, in the step S304, the encoding device 200 is arranged to write each of the bits of the binary data of the dimming control signal S2 into the least significant bit of each of the sub-pixel drive signals of the first set of the RGB data stream S0′, respectively, to produce a first set of the encoded RGB data stream. Moreover, the encoding device 200 is further arranged to produce the encoded RGB data stream S1_1 by replacing the first set of the RGB data stream S0′ of the RGB data stream S0 with the first set of the encoded RGB data stream. The process ends at the step S304.

For example, when the backlight module 104 has 600 backlight blocks and each of the backlight blocks has 64 different degrees of brightness, the dimming control signal S2 includes 600 binary data, and each of the 600 binary data has 6 bits. Namely, the dimming control signal S2 has 3600 bits of binary data. Therefore, the processing unit 202 requires the least significant bit of each of the 3600 sub-pixel drive signals of the RGB data stream S0_1 to write the dimming control signal S2 and produce the encoded RGB data stream S1_1. Namely, the processing unit 202 requires the least significant bit of each of 1200 pixel drive signals of the RGB data stream S0_1 to write the dimming control signal S2 and produce the encoded RGB data stream S1_1. In the other word, each row of the display unit 102 has 1920 pixels when the display unit 102 has a resolution of 1920×1080 (full high definition: FHD). Therefore, the processing unit 202 only requires one row of pixels to write the dimming control signal S2 into the least significant bit of each of the sub-pixel drive signals of the first set of the RGB data stream S0′. Moreover, the processing unit 202 only needs to select a row drive signal of the RGB data stream S0_1 from each frame to serve as the first set of the RGB data stream S0′. In the other embodiments, the processing unit 202 can select more than one row drive signals of the RGB data stream S0_1 in each frame to serve as the first set of the RGB data stream S0′ when the processing unit 202 requires more than one row of the sub-pixel drive signals to write the dimming control signal S2 into the least significant bit of each of the sub-pixel drive signals. For example the processing unit 202 can select two rows of the drive signals, three rows of the drive signals, or less than one row of the drive signals, and is not limited thereto.

In one of the exemplary embodiments, when the backlight module 104 only has two backlight blocks and each of the backlight blocks has 64 different degrees of brightness, the dimming control signal S2 includes two set of binary data, and each of the two set of binary data has 6 bits. Namely, the dimming control signal S2 has 12 bits of binary data. Therefore, the processing unit 202 requires the least significant bit of each of 12 sub-pixel drive signals of the RGB data stream S0_1 to write the dimming control signal S2 and produce the encoded RGB data stream S1_1. Namely, the processing unit 202 requires the least significant bit of each of 4 pixel drive signals of the RGB data stream S0_1 to write the dimming control signal S2 and produce the encoded RGB data stream S1_1.

The processing unit 202 selects the first set of the RGB data stream S0′ from the RGB data stream S0_1 (step S300). As FIG. 2 shows, the sub-pixel drive signals R, G, and B of the pixel drive signal SA1 can be 132, 151, and 232. The sub-pixel drive signals R, G, and B of the pixel drive signal SA2 can be 138, 156, and 213. The sub-pixel drive signals R, G, and B of the pixel drive signal SA3 can be 134, 159, and 225. The pixel drive signal SA4 can be 135, 152, and 211. Next, the processing unit 202 resets the sub-pixel drive signals to zero according to step S302. The sub-pixel drive signals R, G, and B of the pixel drive signal SA1 are replaced by 132, 150, and 232. The sub-pixel drive signals R, G, and B of the pixel drive signal SA2 are replaced by 138, 156, and 212. The sub-pixel drive signals R, G, and B of the pixel drive signal SA3 are replaced by 134, 158, and 224. The drive signals R, G, and B of the pixel drive signal SA4 are replaced by 134, 152, and 210. Finally, the processing unit 202 writes the bits of the dimming control signal S2 into the least significant bits of each of the sub-pixel drive signals which have been reset (step S304). For example, the processing unit 202 writes the bits of the binary data of the dimming control signal S2 corresponding to a first backlight block into the least significant bit of each of the pixel drive signals SA1-SA2, and writes the bits of the binary data of the dimming control signal S2 corresponding to a second backlight block into the least significant bit of each of the pixel drive signals SA3-SA4. For example, when the backlight module 104 only has two backlight blocks and each of the backlight blocks has 64 different degrees of brightness, the processing unit 202 needs 12 sub-pixel drive signals of the RGB data stream S0_1 to write the dimming control signal S2 into the least significant bit of each of the sub-pixel drive signals for producing the encoded RGB data stream S1_1. Namely, the processing unit 202 needs 4 pixel drive signals of the RGB data stream S0_1 to write the dimming control signal S2 into the least significant bits of each of the sub-pixel drive signals of the 4 pixel drive signals for producing the encoded RGB data stream S1_1. In the other word, the processing unit 202 replaces the least significant bit of each of the 12 sub-pixel drive signals with the bits of the dimming control signal S2, respectively, to produce the encoded RGB data stream S1_1, wherein the encoded RGB data stream S1_1 is arranged to be provided to the backlight driver 112 to control the brightness of the two backlight blocks of the backlight module 104.

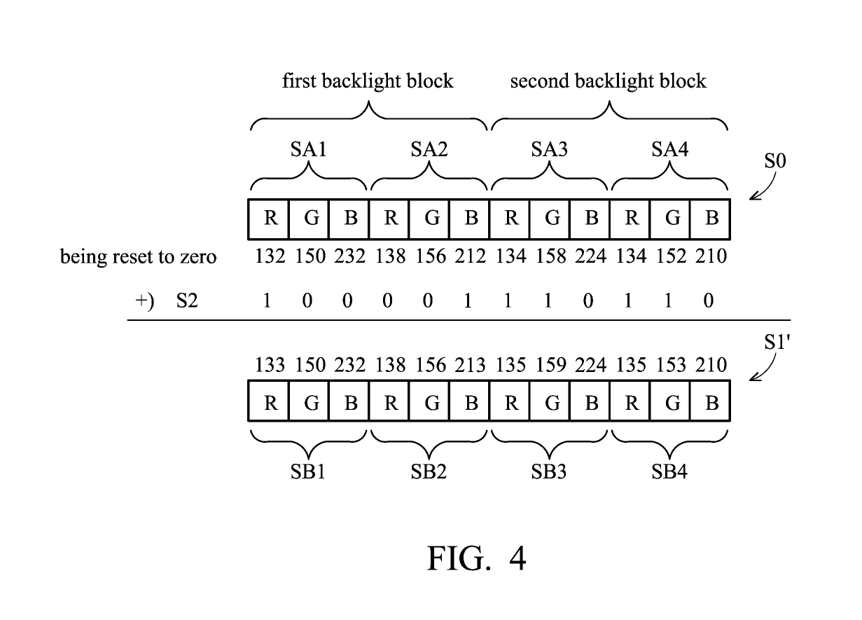

For example, when the vales of the dimming control signal S2 corresponding to the two backlight locks are 33 and 54, the processing unit 202 writes “100001” which corresponds to the binary data “33” into the least significant bit of each of the sub-pixel drive signals (132, 150, 232, 138, 156, and 212) of the pixel drive signals SA1-SA2 and writes “110110” which corresponds to the binary data “54” into the least significant bit of of the sub-pixel drive signals (134, 158, 224, 134, 152, and 210) of the pixel drive signals SA3-SA4 to produce the encoded RGB data stream S1_1. The sub-pixel drive signals of the pixel drive signals SB1-SB42, which correspond to the pixel drive signals SA1-5A4, of the encoded RGB data stream S1_1 are 133, 150, 232, 138, 156, 213, 135, 159, 224, 135, 153, and 210, respectively, as FIG. 4 shows.

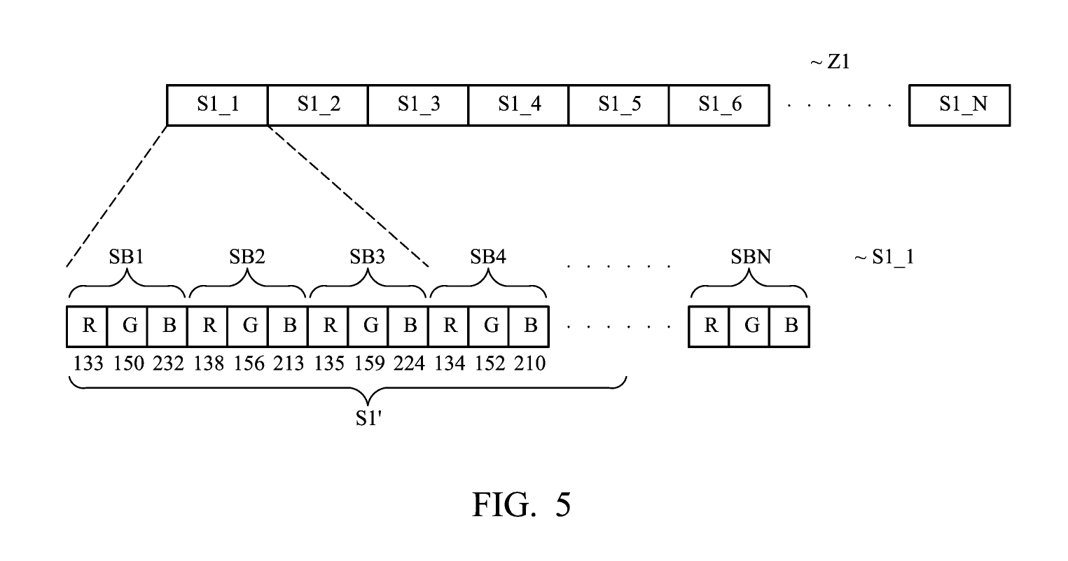

FIG. 5 is a schematic diagram illustrating an embodiment of a data stream according to the present disclosure. The data stream Z1 includes at least one encoded RGB data stream S1_1-S1_N. It should be noted that the following discussion is based on the encoded RGB data stream S1_1. The encoded RGB data stream S1_1 is constituted by the pixel drive signals SB1-SBN corresponding to a plurality of pixels. The pixel drive signals SB1-SBN correspond to the pixel drive signals SA1-SAN shown in FIG. 2 and FIG. 4. Each of the pixel drive signals SB1-SBN includes 3 sub-pixel drive signals R, G, and B. The 3 sub-pixel drive signals R, G, and B are arranged to control the brightness of the red sub-pixel, the green sub-pixel, and the blue sub-pixel of each of the pixels, respectively. The sub-pixel drive signals R, G, and B are binary data. For example, as FIG. 4 shows, the sub-pixel drive signals R, G, and B of the pixel drive signal SB 1 of the encoded RGB data stream S1_1 which is produced by encoding the RGB data stream S0_1 can indicate the grayscale values 133, 150, and 232 by using binary data, respectively. The sub-pixel drive signals R, G, and B of the pixel drive signal SB2 can indicate the grayscale values 138, 156, and 213 by using binary data, respectively. The sub-pixel drive signals R, G, and B of the pixel drive signal SB3 can indicate the grayscale values 135, 159, and 224 by using binary data, respectively. Furthermore, the sub-pixel drive signals R, G, and B of the pixel drive signal SB4 can indicate the grayscale values 134, 152, and 210 by using binary data, respectively. It should be noted that bigger sub-pixel drive signal indicates higher brightness of the corresponding sub-pixel. Moreover, the data stream Z1 can be divided a plurality of the frame drive signals by frames (the encoded RGB data streams S1_1-S1_N) according to the vertical synchronization signal, and each of the frame drive signals (the encoded RGB data streams S1_1-S1_N) can be divided into a plurality of row drive signals by rows according to the horizontal synchronizing signal. Each of the encoded RGB data streams S1_1-S1_N corresponding to each of the frames includes a first set of the encoded RGB data stream S1′, wherein the dimming control signal S2 is obtained by arranging each of the least significant bit of each of the sub-pixel drive signals of the first set of the encoded RGB data stream S1′ in sequence.

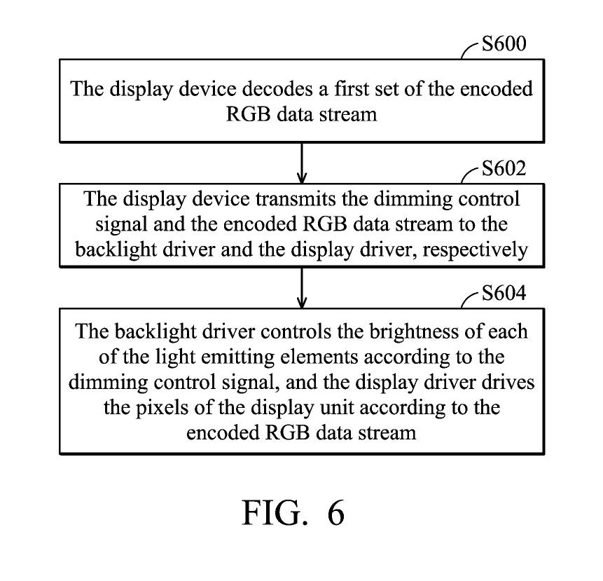

FIG. 6 is a flowchart of a displaying method according to an embodiment according to the present disclosure. The process starts at step S600. It should be noted that the following discussion is based on the encoded RGB data stream S1_1, but is not limited thereto.

In the step S600, the display device 100 is arranged to decode a first set of the encoded RGB data stream S1′ of the encoded RGB data stream S1_1 to produce a dimming control signal S2. In the embodiment, the encoded RGB data stream S1_1 is provided to the display driver 106 for driving a plurality of pixels of the display unit 102 to display a frame, and the first set of the encoded RGB data stream S1′ corresponds to a row of pixels of the display unit 102 (or a row of pixels of the frame). For example, the data of the encoded RGB data stream S1_1 is retrieved by the buffer unit 108 in sequential order by rows, and provided to the decoding device 110 for decoding. In another embodiment, the buffer unit 108 is arranged to retrieve the data corresponding to a row of pixels of the first set of the encoded RGB data stream from the encoded RGB data stream S1_1 to serve as the first set of the encoded RGB data stream S1′ according to the horizontal sync signal or the vertical sync signal. The decoding device 110 is arranged to retrieve each of the least significant bit of each of the sub-pixel drive signals of the first set of the encoded RGB data S1′, and arrange the least significant bit of each in sequence to constitute the dimming control signal S2. The pixel drive signals of the encoded RGB data stream S1_1 are arranged to drive the sub-pixels of the display unit 102. In one of the exemplary embodiments, the first set of the encoded RGB data stream S1′ of the RGB data stream S1_1 is the data corresponding to the first row of pixels, and the decoding device 110 decodes the first set of the encoded RGB data stream S1′ in the buffer unit to produce the dimming control signal S2 when the buffer unit 108 is retrieving the data of the first row of pixels of the encoded RGB data stream S1_1. In another embodiment, the first set of the encoded RGB data stream S1′ is arranged to drive the last row of pixels of a frame, and the decoding device 110 decodes the first set of the encoded RGB data stream S1′ in the buffer unit 108 to produce the dimming control signal S2 when the buffer unit 108 is retrieving the data of the last row of pixels of the encoded RGB data stream S1_1. It should be noted that the buffer unit 108 and the decoding device 110 can identify the first set of the encoded RGB data stream S1′ from the encoded RGB data stream S1_1 according to the horizontal sync signal or the vertical sync signal.

Next, in the step S602, the display device 100 is arranged to transmit the dimming control signal S2 and the encoded RGB data stream S1_1 to the backlight driver 112 and the display driver 106, respectively.

Next, in the step S604, the backlight driver 112 is arranged to control the brightness of each of the light emitting elements of the backlight module 104 according to the dimming control signal S2, and the display driver 106 is arranged to drive the pixels arranged in a matrix of the display unit 102 according to the encoded RGB data stream S1_1. The process ends at the step S604.

For example, the display device 100 decodes the encoded RGB data stream S1_1 as FIG. 5 shows. The decoding device 110 is arranged to retrieve the least significant of each of the sub-pixel drive signals (1, 0, 0, 0, 0, 1, 1, 1, 0, 1, 1, and 0) of the sub-pixel drive signals of the pixel drive signals SB1-SB4 of the first set of the encoded RGB data stream S1′, and arrange the least significant bit of each of the sub-pixel drive signals in sequence to constitute the dimming control signal S2 (100001110110) when the buffer unit 108 retrieves the first set of the encoded RGB data stream S1′, wherein the decoding device 110 is further arrange to transmit the dimming control signal S2 to the backlight driver 112. The backlight driver 112 is arranged to divide the bits of the dimming control signal S2 into a plurality of binary data corresponding to the backlight blocks, respectively, according to the encoding method of the encoded RGB data stream S1_1, wherein the backlight driver 112 is further arranged to transmit the plurality of binary data to the corresponding backlight blocks to drive the corresponding backlight blocks. In this embodiment, the backlight driver 112 divides the dimming control signal S2 “100001110110” into binary data “100001” corresponding to the first backlight block and binary data “110110” corresponding to the second backlight block.

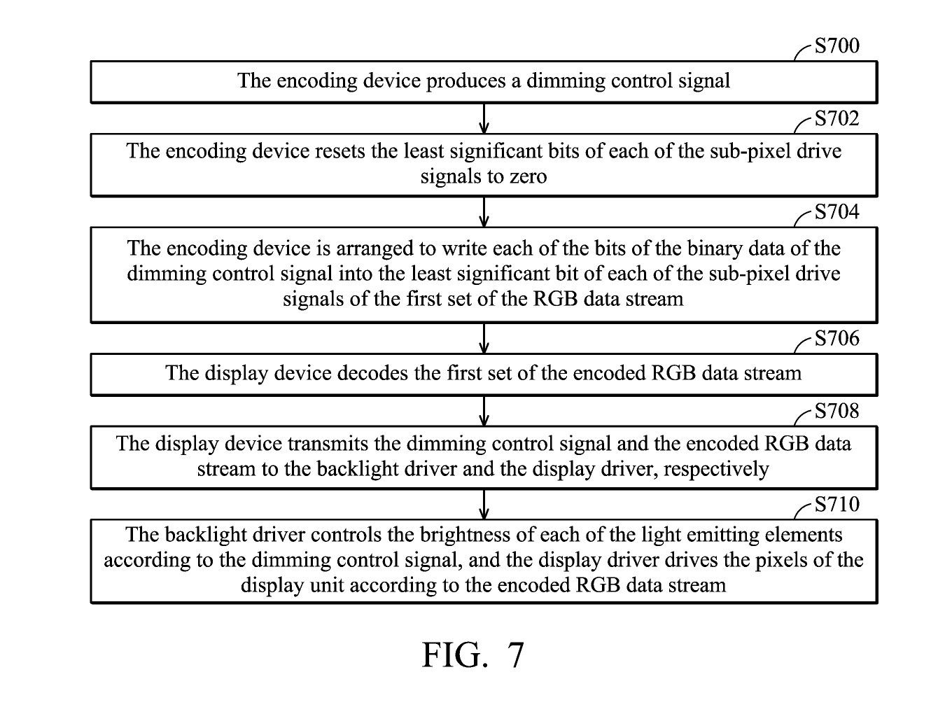

FIG. 7 is a flowchart of another displaying method according to an embodiment according to the present disclosure, wherein the displaying method is applied to the playback system 1000. The process starts at step S700. It should be noted that the following discussion is based on the RGB data stream S0_1 and the encoded RGB data stream S1_1, but is not limited thereto.

In the step S700, the encoding device 200 is arranged to produce a dimming control signal S2 which corresponds to the RGB data stream S0_1 according to an RGB data stream S0_1. For example, the dimming control signal S2 is arranged to be provided to the backlight driver 112 and used for controlling the brightness of a plurality of light emitting elements, wherein the dimming control signal S2 is binary data.

Next, in the step S702, the encoding device 200 is arranged to reset the least bits of each of the sub-pixel drive signals of a first set of the RGB data stream S0′ of the sub-pixel drive signals of the RGB data stream S0_1 to zero. The sub-pixel drive signals of the RGB data stream S0_1 are binary data provided to the display driver 106 for driving a plurality of sub-pixels of the pixels arranged in a matrix of the display unit 102. It should be noted that the processing unit 202 is arranged to select one of the row drive signals from the RGB data stream S0_1 to serve as the first set of the RGB data stream S0′ according to the horizontal synchronizing signal or the vertical synchronization signal. The first set of the RGB data stream S0′ is arranged to drive the first row or the last row of the pixels, but, is not limited thereto. In one of the exemplary embodiments, the processing unit 202 divides each of the sub-pixel drive signals of the first set of the RGB data stream S0′ by two to obtain a quotient and discards the remainder, and then multiplies the quotient by two, such that the least significant bit of each of the sub-pixel drive signals of the first set of the RGB data stream S0′ are reset to zero, but is not limited thereto. In another embodiment, the processing unit 202 is arranged to ignore the least significant bit of each of the sub-pixel drive signals of the first set of the RGB data stream S0′, and serve zero as the least significant bit of each of the sub-pixel drive signals of the first set of the RGB data stream S0′, such that the least significant bit of each of the sub-pixel drive signals of the first set of the RGB data stream S0′ are reset to zero, but is not limited thereto.

Next, in the step S704, the encoding device 200 is arranged to write each of the bits of the binary data of the dimming control signal S2 into the least significant bit of each of the sub-pixel drive signals of the first set of the RGB data stream S0′, respectively, to produce a first set of the encoded RGB data stream S1′. Moreover, the encoding device 200 is further arranged to produce the encoded RGB data streams S1_1-S1_N by replacing the first set of the RGB data stream S0′ of the RGB data stream S0_1 with the first set of the encoded RGB data stream S1′.

in the step S706, the display device 100 is arranged to decode the first set of the encoded RGB data stream S1′ of the encoded RGB data stream S1_1, wherein the first set of the encoded RGB data stream S1′ corresponds to a row of pixels of the display unit 102 (or a row of pixels of the frame). The data of the encoded RGB data stream S1_1 is retrieved by the buffer unit 108 of the display device 100 in sequential order by rows, and provided to the decoding device 110 for decoding. In another embodiment, the buffer unit 108 is arranged to retrieve the data corresponding to a row of pixels of the first set of the encoded RGB data stream from the encoded RGB data stream S1 to serve as the first set of the encoded RGB data stream S1′ according to the horizontal sync signal or the vertical sync signal. The decoding device 110 is arranged to retrieve the least significant bits of each of the sub-pixel drive signals SA1-SAN of the first set of the encoded RGB data stream S1′, and arrange the least significant bit of each of the sub-pixel drive signals SA1-SAN in sequence to constitute the dimming control signal S2. The pixel drive signals SB1-SBN of the encoded RGB data stream S1_1 are provided to the display driver 106, and used for driving the sub-pixels of the display unit 102. In one of the exemplary embodiments, the first set of the encoded RGB data stream S1′ is arranged to drive the first row of pixels, the decoding device 110 decodes the first set of the encoded RGB data stream S1′ in the buffer unit to produce the dimming control signal S2 when the buffer unit 108 retrieves the data of the first row of pixels of the encoded RGB data stream S1_1. Namely, the first set of the encoded RGB data stream S1′ is arranged to drive the first row of pixels of a frame, and the decoding device 110 decodes the first set of the encoded RGB data stream S1′ in the buffer unit to produce the dimming control signal S2. In another embodiment, the first set of the encoded RGB data stream S1′ is arranged to drive the last row of pixels of a frame, the decoding device 110 decodes the first set of the encoded RGB data stream S1′ in the buffer unit to produce the dimming control signal S2 when the buffer unit 108 retrieves data of the last row of pixels of the encoded RGB data stream S1_1. It should be noted that the buffer unit 108 and the decoding device 110 can identify the first set of the encoded RGB data stream S1′ from the encoded RGB data stream S1_1 according to the horizontal sync signal or the vertical sync signal.

Next, in the step S708, the display device 100 is arranged to transmit the dimming control signal S2 and the encoded RGB data stream S1_1 to the backlight driver 112 and the display driver 106, respectively.

Next, in the step S710, the backlight driver 112 is arranged to control the brightness of each of the light emitting elements of the backlight module 104 according to the dimming control signal S2, and the display driver 106 is arranged to drive the pixels arranged in a matrix of the display unit 102 according to the encoded RGB data stream S1_1, wherein each of the pixels includes a plurality of sub-pixels. The process ends at the step S710.

Data transmission methods, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application-specific logic circuits.

While the disclosure has been described by way of example and in terms of the preferred embodiments, it is to be understood that the disclosure is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A display device, comprising:
a display unit, comprising a plurality of pixels arranged in a matrix, wherein each of the pixels comprises a plurality of sub-pixels;
a backlight module, comprising a plurality of light emitting elements;
a decoding device, arranged to decode an encoded RGB data stream to produce a dimming control signal, wherein the encoded RGB data stream is arranged to drive each of the sub-pixels of the display unit to display a frame, the encoded RGB data stream comprises a first set of the encoded RGB data stream, the first set of the encoded RGB data stream corresponds to a row of pixels of the frame and has binary data corresponding to each of the light emitting elements, respectively, and the decoding device is arranged to produce the dimming control signal according to the binary data; and
a backlight driver, arranged to control brightness of each of the light emitting elements, respectively, according to the dimming control signal.

2. The display device as claimed in claim 1, wherein the encoded RGB data stream comprises a plurality of sub-pixel drive signals corresponding to each of the sub-pixels, respectively, and the dimming control signal is constituted by the least significant bit of each of the sub-pixel drive signals of the first set of the encoded RGB data stream.

3. The display device as claimed in claim 1, further comprising a buffer unit arranged to retrieve data corresponding to the row of pixels of the frame from the encoded RGB data stream to serve as the first set of the encoded RGB data stream.

4. The display device as claimed in claim 3, wherein the buffer unit is arranged to retrieve data corresponding to the first row of pixels of the frame from the encoded RGB data stream to serve as the first set of the encoded RGB data stream.

5. The display device as claimed in claim 3, wherein the buffer unit is arranged to retrieve data corresponding to the last row of pixels of the frame from the encoded RGB data stream to serve as the first set of the encoded RGB data stream.

6. The display device as claimed in claim 1, further comprising a display driver arranged to drive each of the pixels of the display unit according to the encoded RGB data stream.

7. A display method, applied to a display device comprising a display unit, wherein the display unit comprises a plurality of pixels arranged in a matrix and each of the pixels comprises a plurality of sub-pixels, the display method comprising:
decoding a first set of the encoded RGB data stream of an encoded RGB data stream to produce a dimming control signal, wherein the encoded RGB data stream is provided to a display driver and used for driving the pixels of the display unit to display a frame, and the first set of the encoded RGB data stream corresponds to a row of pixels of the frame;
transmitting the dimming control signal and the encoded RGB data stream to a backlight driver and the display driver;
controlling brightness of a plurality of light emitting elements of a backlight module according to the dimming control signal; and
driving the pixels of the display unit according to the encoded RGB data stream.

8. The display method as claimed in claim 7, wherein the step of decoding the first set of the encoded RGB data stream of the encoded RGB data stream comprises retrieving the least significant bit of each of a plurality of the sub-pixel drive signals of the first set of the encoded RGB data stream, and arranging each of a plurality of the sub-pixel drive signals in sequence to constitute the dimming control signal.

9. The display method as claimed in claim 7, wherein the step of decoding the first set of the encoded RGB data stream of the encoded RGB data stream comprises retrieving data corresponding to the row of pixels of the frame from the encoded RGB data stream into a buffer unit of the display device to serve as the first set of the encoded RGB data stream.

10. The display method as claimed in claim 9, wherein the first set of the encoded RGB data stream of the encoded RGB data stream corresponds to the first row of pixels of the frame.

11. The display method as claimed in claim 9, wherein the first set of the encoded RGB data stream of the encoded RGB data stream corresponds to the last row of pixels of the frame of the encoded RGB data stream.

12. An encoding method, applied to an encoding device, comprising:
producing a dimming control signal corresponding to an RGB data stream according to the RGB data stream, wherein the dimming control signal is provided to a backlight driver to control brightness of a plurality of light emitting elements of a backlight module, and the dimming control signal is binary data;
resetting the least significant bit of each of a plurality of sub-pixel drive signals of a first set of the RGB data stream of the RGB data stream to zero, wherein the sub-pixel drive signals are binary data; and
writing each of bits of the binary data of the dimming control signal into the least significant bit of each of the sub-pixel drive signals, respectively, to produce an encoded RGB data stream.

13. The encoding method as claimed in claim 12, wherein the step of resetting the least significant bit of each of the sub-pixel drive signals of the first set of the RGB data stream of the RGB data stream to zero comprises dividing each of the sub-pixel drive signals of the first set of the RGB data stream by two to obtain a quotient, and multiplying the quotient by two.

14. The encoding method as claimed in claim 12, wherein the step of resetting the least significant bit of each of the sub-pixel drive signals of the first set of the RGB data stream of the RGB data stream to zero comprises ignoring the least significant bit of each of the sub-pixel drive signals of the first set of the RGB data stream, and serving zero as the least significant bit of each of the sub-pixel drive signals of the first set of the RGB data stream.

15. The encoding method as claimed in claim 12, wherein the first set of the RGB data stream of the encoded RGB data stream corresponds to the first row of pixels of the frame.

16. The encoding method as claimed in claim 12, wherein the first set of the RGB data stream of the encoded RGB data stream corresponds to the last row of pixels of the frame.

17. A display method, comprising:
producing a dimming control signal corresponding to an RGB data stream according to the RGB data stream, wherein the dimming control signal is binary data;
resetting the least significant bit of each of a plurality of sub-pixel drive signals of a first set of the RGB data stream of the RGB data stream to zero, wherein the sub-pixel drive signals are binary data;
writing each of bits of the binary data of the dimming control signal into the least significant bit of each of the sub-pixel drive signals, respectively, to produce at least one encoded RGB data stream;
decoding a first set of the encoded RGB data stream of the encoded RGB data stream to produce the dimming control signal, wherein the first set of the encoded RGB data stream corresponds to a row of pixels of a frame;
transmitting the dimming control signal and the encoded RGB data stream to a backlight driver and a display driver;
controlling brightness of a plurality of light emitting elements of a backlight module according to the dimming control signal; and
driving a plurality of pixels of a display unit according to the encoded RGB data stream, wherein the pixels are arranged in a matrix.

18. The display method as claimed in claim 17, wherein the step of resetting the least significant bit of each of the sub-pixel drive signals of the first set of the RGB data stream of the RGB data stream to zero further comprises dividing each of the sub-pixel drive signals of the first set of the RGB data stream by two to obtain a quotient, and multiplying the quotient by two.

19. The display method as claimed in claim 17, wherein the step of resetting the least significant bit of each of the sub-pixel drive signals of the first set of the RGB data stream of the RGB data stream to zero comprises ignoring the least significant bit of each of the sub-pixel drive signals of the first set of the RGB data stream, and serving zero as the least significant bit of each of the sub-pixel drive signals of the first set of the RGB data stream.

20. The display method as claimed in claim 17, wherein the step of decoding the first set of the encoded RGB data stream of the encoded RGB data stream comprises retrieving the least significant bit of each of a plurality of the sub-pixel drive signals of the first set of the encoded RGB data stream to constitute the dimming control signal.

21. The display method as claimed in claim 17, wherein the step of decoding the first set of the encoded RGB data stream of the encoded RGB data stream further comprises retrieving data corresponding to the row of pixels of the frame from the encoded RGB data stream into a buffer unit of the display device to serve as the first set of the encoded RGB data stream.

22. The display method as claimed in claim 21, wherein the first set of the encoded RGB data stream of the encoded RGB data stream corresponds to the first row of pixels of the frame.

23. The display method as claimed in claim 21 wherein the first set of the encoded RGB data stream of the encoded RGB data stream corresponds to the last row of pixels of the frame.
